(19) United States
(12) Patent Application Publication
(10) Pub. No.: US 2010/0090885 A1
(43) Pub. Date: Apr. 15, 2010

(54) DIGITAL RADAR SYSTEMS AND METHODS

(75) Inventor: UDAYAN MALLIK, New Carrolton, MD (US)

Correspondence Address: NASA GODDARD SPACE FLIGHT CENTER, 8800 GREENBELT ROAD, MAIL CODE 140.1, GREENBELT, MD, 20771, US

(73) Assignee: NASA HQ's, Washington, DC (US)

(21) Appl. No.: 12/555,611

(22) Filed: Sep. 8, 2009

Related U.S. Application Data
(60) Provisional application No. 61/105,458, filed on Oct. 15, 2008.

(51) Int. Cl. G01S 13/00

(52) U.S. Cl. 342/195

(57) ABSTRACT

A digital radar system includes a transmitter, the transmitter configured to transmit a signal; a receiver, the receiver configured to receive a return signal; and two analog to digital conversion (ADC) units, the ADC units configured to digitize the return signal at a rate higher than a Nyquist rate for the transmitted signal. A method of operating a digital radar includes transmitting a signal via a transmitter; receiving a return signal via a receiver; and digitizing the return signal by two analog to digital conversion (ADC) units at a rate higher than a Nyquist rate for the transmitted signal.

This application claims the benefit of U.S. Provisional Application No. 61/054,458 (Mallik), filed on Oct. 15, 2008.

### STATEMENT OF GOVERNMENT INTEREST

The invention described herein was made by an employee of the United States Government and may be manufactured and used by or for the Government of the United States of America for governmental purposes without payment of any royalties thereon or therefor.

### BACKGROUND

This disclosure relates generally to the field of digital radar systems.

Modern radar systems tend to be relatively large devices, comprising specialized hardware components that are specifically designed to perform various radar functions. Use of such specialized components in a radar system may increase the radar's design cost, power consumption, size and weight. Further, use of specialized components for signal processing and display functions may greatly increase system complexity, and increase the amount of data to be transferred to a display unit, which may greatly limit overall radar system speed, as a major limiting factor for radar performance is the rate of available data transfer protocols.

### BRIEF SUMMARY

An exemplary embodiment of a digital radar system includes a transmitter, the transmitter configured to transmit a signal; a receiver, the receiver configured to receive a return signal; and two analog to digital conversion (ADC) units, the ADC units configured to digitize the return signal at a rate higher than a Nyquist rate for the transmitted signal.

An exemplary embodiment of a method of operating a digital radar includes transmitting a signal via a transmitter; receiving a return signal via a receiver; and digitizing the return signal by two analog to digital conversion (ADC) units at a rate higher than a Nyquist rate for the transmitted signal.

Additional features are realized through the techniques of the present exemplary embodiment. Other embodiments are described in detail herein and are considered a part of what is claimed. For a better understanding of the features of the exemplary embodiment, refer to the description and to the drawings.

### BRIEF DESCRIPTION OF THE SEVERAL VIEWS OF THE DRAWINGS

Referring now to the drawings wherein like elements are numbered alike in the several FIGURES:

FIG. 1 illustrates an embodiment of a continuous mode digital radar.

FIG. 2 illustrates an embodiment of a burst mode digital radar.

FIG. 3 illustrates an embodiment of a method of transmitting a signal using a digital radar.

FIG. 4 illustrates an embodiment of a method of receiving a signal using a digital radar.

FIG. 5 illustrates an embodiment of a method of data transfer implemented in a continuous mode digital radar.

FIG. 6 illustrates an embodiment of a computer that may be used in conjunction with embodiments of a digital radar.

### DETAILED DESCRIPTION

Embodiments of systems and methods for a digital radar are provided, with exemplary embodiments being discussed below in detail.

Embodiments of a digital radar may be relatively small in size, comprising only commercially available components, including digital complementary metal-oxide-on-semiconductor (CMOS) components; analog circuits may be restricted to signal amplification and analog to digital converter (ADC) functions. Signal processing and display functions may be performed in software on an attached personal computer (PC). Embodiments of a digital radar may comprise a 1 GHz, L-band digital radar, operating at a pulse repetition rate (PRR) up to 10 MHz, with 8 received RF samples per pulse repetition interval (PRI), or the digital radar may operate at a PRR up to 19 KHz with 4K received RF samples per PRI. The PRR and number of samples per PRI may be varied depending on the application for which the radar is used.

The digital radar achieves a sampling rate well above the 2 GHz Nyquist rate required for 1 GHz radar; therefore, the temporal distribution of radio frequency (RF) samples acquired and reported to the radar processor is uniform and free of distortion. The digital radar does not require an intermediate frequency (IF) downsample stage. Some embodiments of a digital radar may comprise a continuous mode digital radar, including real-time signal processing and display. Other embodiments may comprise a burst mode digital radar.

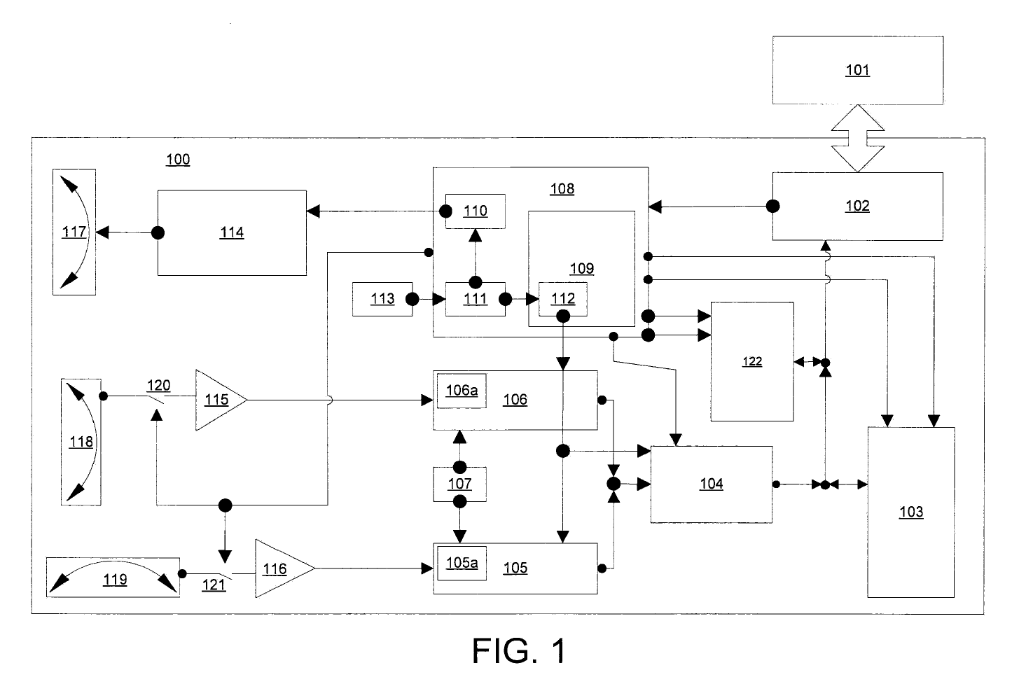

FIG. 1 illustrates an embodiment of a continuous mode digital radar system. PC 101 communicates with the radar front end electronics 100 via universal serial bus (USB) interface 102. In some embodiments, the connection to PC 101 may comprise a high-speed USB link. Field-programmable gate array (FPGA) 108 controls the radar electronics 100. FPGA 108 comprises a phase locked loop (PLL) 110, random access memory (RAM) address and controls 109, a system clock 111, and a local clock 112.

Embodiments of radar front end electronics 100 for a continuous mode radar such as is shown in FIG. 1 may comprise 8 printed circuit boards (PCBs) stacked vertically, connected with high speed connectors. PCB 1 may comprise transmission antenna 117. PCB 2 may comprise orthogonal receive antennae 118 and 119. PCB 3 may comprise FPGA 108, master oscillator 113, amplifier 114, ADCs 105 and 106, sampling clock 107, FIFO 104, and uplink buffer 122. PCB 4 may comprise USB interface 102. PCBs 5, 6, 7, and 8 may comprise system memory 103.

FPGA 108 may comprise an Actel FPGA. ACDs 105 and 106 may comprise National Semiconductor ADCs, and may have a sampling rate of 3 gigasamples per second (GSPS). Embodiments of ADC on-chip memories 105a and 106a may comprise 4 KB on-chip digital memory units that are asynchronously readable at speeds up to 200 MHz. Master oscillator 113 may comprise a 600 MHz oscillator. Sampling clock 107 may comprise a 1.5 GHz oscillator. FIFO 104 may comprise two 1 MB FIFOs, and uplink buffer 122 may comprise a 128 Mx8 SDRAM unit. System memory 103 may comprise a 32.75 GB SDRAM implemented in 4 8×8 arrays of 128Mx8 SDRAM memory ICs. PC 101 may control all front end radar electronics 100 via the USB interface 102.

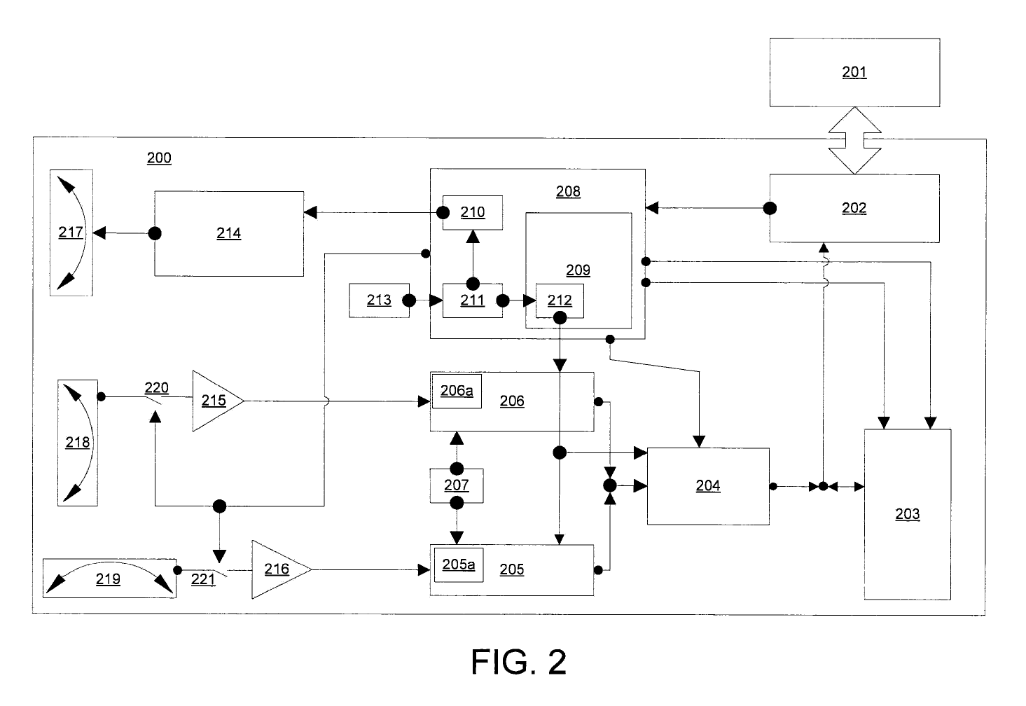

FIG. 2 illustrates an embodiment of a burst mode digital radar. PC 201 communicates with the radar electronics 200 via USB interface 202. In some embodiments, the connection to PC 201 may comprise a high-speed USB link. FPGA 208 controls the radar electronics 200. FPGA 208 comprises a PLL 210, RAM address and controls 209, a system clock 211, and a local clock 212. System clock 211 is controlled by oscillator 213. System clock 211 controls local clock 212 and PLL 210. PLL 210 synthesizes and transmits a pulse to amplifier 214, which amplifies the pulse for transmission on transmission antenna 217. The return signal is received on orthogonal receiver antennae 218 and 219. The return signal is sent from antenna 218 to ADC 206 via RF switch 220 and low-noise amplifier 215, and from antenna 219 to ADC 205 via RF switch 221 and low-noise amplifier 216. RF switch 220 and RF switch 221 are controlled by FPGA 208. RF switches 220 and 221 are open to protect the receiver electronics from strong field emissions during the transmission cycle, and are closed during the receiving cycle. ADC 205 and ADC 206 are connected to sampling clock 107 and to local clock 212. ADCs 205 and 206 comprise on-chip memories 205a and 206a, respectively. ADCs 205 and 206 sample the received signal and transfer the sampled signal to system memory 203 via FIFO 204. Data is transferred from system memory 203 via USB interface 202 to PC 201.

Embodiments of radar front end electronics 200 for a burst mode radar such as is shown in FIG. 2 may comprise 5 printed circuit boards (PCBs) stacked vertically, connected with high speed connectors. PCB 1 may comprise transmission antenna 217. PCB 2 may comprise orthogonal receive antennae 218 and 219. PCB 3 may comprise FPGA 208, master oscillator 213, amplifier 214, ADCs 205 and 206, sampling clock 207, and FIFO 204. PCB 4 may comprise USB interface 202. PCB 5 may comprise system memory 203.

FPGA 208 may comprise an Actel FPGA. ACDs 205 and 206 may comprise National Semiconductor ADCs, and may have a sampling rate of 3GSPS. Embodiments of ADC on-chip memories 205a and 206a may comprise 4 KB on-chip digital memory units that are asynchronously readable at speeds up to 200 MHz. Master oscillator 213 may comprise a 600 MHz oscillator. Sampling clock 207 may comprise a 1.5 GHz oscillator. FIFO 204 may comprise two 1 MB FIFOs. System memory 203 may comprise a 6 GB SDRAM implemented in an 8×8 array of 128Mx8 SDRAM memory ICs. PC 201 may control all front end radar electronics 200 via the USB interface 202.

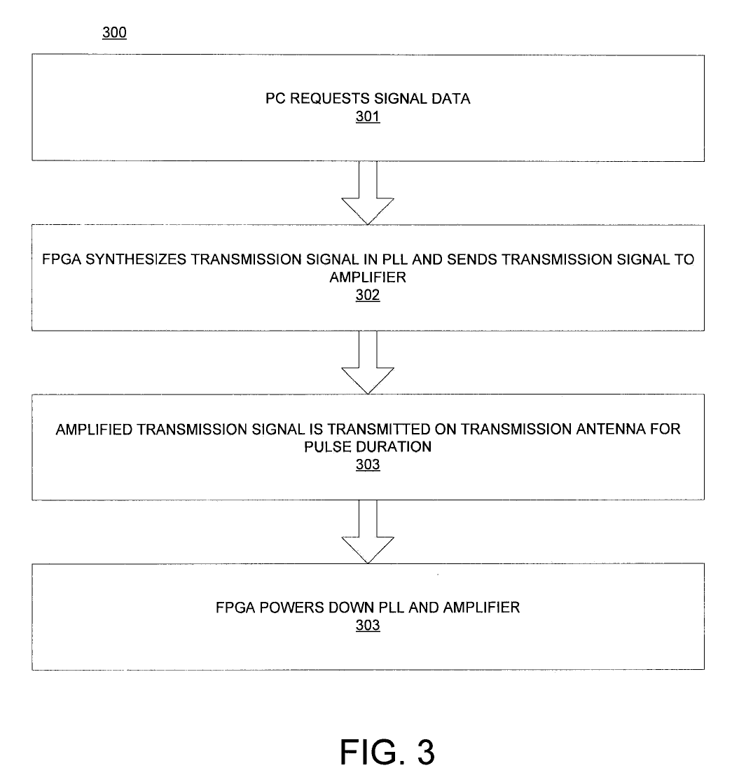

FIG. 3 illustrates an embodiment of a method 300 for transmitting a signal using a digital radar. FIG. 3 is described with reference to both FIGS. 1 and 2. In block 301, PC (101, 202) initiates a request for data, and transmits the request to the FPGA (108, 208) in the front end electronics (100, 200) via the USB interface (102, 202). In block 302, the FPGA (108, 208), upon receipt of the request, synthesizes a transmission signal in the PLL (110, 210) and sends the transmission signal via an output pin to the amplifier (114, 214). The signal may comprise a 1 GHz square wave in some embodiments. In block 303, the amplified transmission signal is sent from the amplifier (114, 214) into the atmosphere on the transmission antenna (117, 217) for the duration of a transmission pulse. The FPGA (108, 208) controls the duration of the transmission pulse; this duration may be configured by a user via the PC (101, 201). In block 304, at the end of the transmission pulse, the FPGA (108, 208) powers down the PLL (110, 210) and the amplifier (114, 214) to deactivate the transmission antenna (117, 217), in order to reduce power consumption and limit interference in the received signal.

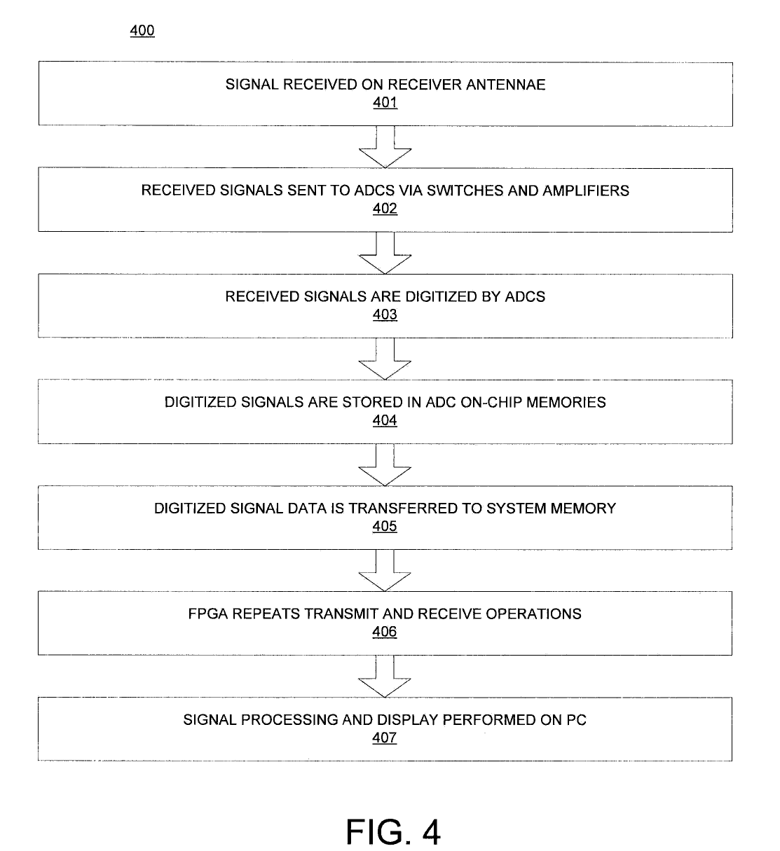

FIG. 4 illustrates an embodiment of a method 400 for receiving a signal using a digital radar. FIG. 4 is described with reference to both FIG. 1 and FIG. 2. In block 401, returning RF signals are received on the receiver antennae (117 and 118; 217 and 218). In block 402, The received signals are sent via switches (120 and 121; 220 and 221) and amplifiers (115 and 116; 215 and 216) to the ADCs (105 and 106; 205 and 206). The switches (120 and 121; 220 and 221) are open to protect the receiver electronics from strong field emissions during the transmission cycle; the switches (120 and 121; 220 and 221) are closed during the receiving cycle. In block 403, the amplified received signals are digitized by the ADCs (105 and 106; 205 and 206). In some embodiments, the ADC sampling rate is about 3 GHz, which is well above the 2 GHz Nyquist rate required for a 1 Ghz transmission signal. In block 404, the digitized signal is stored in the ADC on-chip memories (105a and 106a; 205a and 206a) at the ADC sampling rate. In block 405, at the end of conversion operations, the FPGA (108, 208) stops the ADCs (105 and 106; 205, and 206) and transfers the digitized signal data from the ADC on-chip memories (105a and 106a; 205a and 206a) to the system memory (103, 203) via the FIFO (104, 204). The FIFO acts to buffer the temporal distribution of radar operations against the interruptions caused by periodic row access strobe (RAS) and column address strobe (CAS) operations that may be required by the system memory. In block 406, the FPGA (108, 208) repeats transmit operations (blocks 301-304) and receive operations (blocks 401-405) until either a halt command is received from the PC (101, 201), or until the end of a burst cycle. In block 407, data is transferred from the system memory (103, 203) to the PC (101, 201), and in block 408, signal processing and display of the transferred data are performed on the PC (101, 201). Signal processing and display may be implemented in software on the PC (101, 201) in any appropriate computer language, including but not limited to C++ or MATLAB.

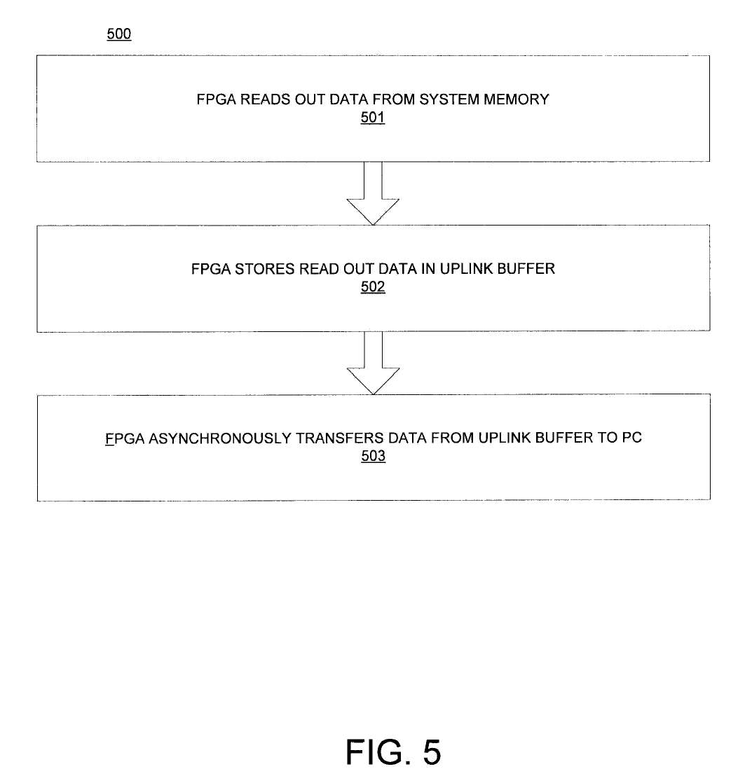

In a continuous embodiment of digital radar, such as is shown in FIG. 1, the radar performs transceiving operations continuously, and data transfer from the system memory 103 to the PC 101 via uplink buffer 122 is performed asynchronously to the transceiving operations. FIG. 5 illustrates an embodiment of a method 600 for data transfer step 407 as implemented a continuous mode digital radar. In block 501, FPGA 108 reads data out of the system memory 103. In block 502, the FPGA stores the read

Signal processing and display on the PC 101 is also performed asynchronously to the continuous radar PRR. The PC 101 may request signal data from FPGA 108 at random intervals of time. System memory 103 may have a shared data and address bus for read and write operations, so data must be written to and read out from system memory 103 in two steps. The radar system may therefore operate at half its maximum PRR, allowing FPGA 108 to write and read back data to and from the system memory 103 at each PRI.

Integration of the system memory unit 103 into the front end 100 increases the PRR of the continuous digital radar. The PRR may also be increased by decreasing the number of recorded samples per PRI. The PRR is limited by the read and write speeds of system memory 103. The inability to directly store digitized patterns into the system memory 103 may reduce system PRR by a factor of up to 18. Embodiments of a continuous digital radar may operate at up to a 19 KHz PRR with 4K recorded samples per ADC per PRI, using a 3GSPS ADC, corresponding to a range of about 400 m in space. The distance surveyed by the radar may be derived using wave speed C=1/√(με); the distance S traveled by a wave at speed C is S=Ct, where μ is the permeability of the traversed medium, ε is the permittivity of the medium, and t is the wave propagation time.

A burst embodiment of a digital radar, such as is shown in FIG. 2, may transceive radio frequency signals without interruption for the duration of a burst cycle, which may be up to about 37 seconds in some embodiments. Data transfer step 407 is performed by FPGA 208 directly from system memory 203 to PC 201 via USB interface 202 at the end of each burst cycle, and signal processing and display are subsequently performed on PC 201. A burst cycle may end when system memory 203 is full of acquired signal data. The burst cycle may be configured to be shorter in some embodiments; the duration of a burst cycle may be set by a user via PC 201. The front end 200 may go into power down mode between burst cycles, until PC 201 requests more signal data. The burst mode radar may be smaller than the continuous mode radar, due to the absence of the uplink buffer and smaller system memory size.

The operating band of a digital radar is limited by the highest sampling rate achievable using available ADCs. As new CMOS technology drives ADC sampling rates higher, the digital radar architecture may be scaled to implement higher bands and transmission frequencies. The observation window of a digital radar may be relatively wide, allowing for use in studies of cloud physics and other atmospheric studies.

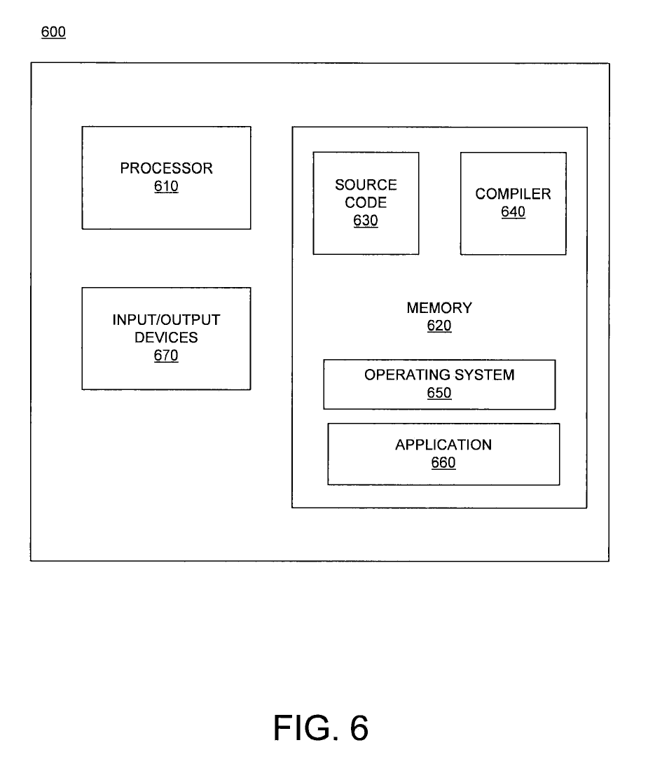

FIG. 6 illustrates an example of a computer 600 which may be utilized in conjunction with exemplary embodiments of a digital radar. Various operations discussed above may utilize the capabilities of the computer 600. One or more of the capabilities of the computer 600 may be incorporated in any element, module, application, and/or component discussed herein.

The computer 600 includes, but is not limited to, PCs, workstations, laptops, PDAs, palm devices, servers, storages, and the like. Generally, in terms of hardware architecture, the computer 600 may include one or more processors 610, memory 620, and one or more input and/or output (I/O) devices 670 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 610 is a hardware device for executing software that can be stored in the memory 620. The processor 610 can be virtually any custom made or commercially available processor, a central processing unit (CPU), a data signal processor (DSP), or an auxiliary processor among several processors associated with the computer 600, and the processor 610 may be a semiconductor based microprocessor (in the form of a microchip) or a macroprocessor.

The memory 620 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 620 may incorporate electronic, magnetic, optical, and/or other types of storage media. Note that the memory 620 can have a distributed architecture, where various components are situated remote from one another, but can be accessed by the processor 610.

The software in the memory 620 may include one or more separate programs, each of which comprises an ordered listing of executable instructions for implementing logical functions. The software in the memory 620 includes a suitable operating system (O/S) 650, compiler 640, source code 630, and one or more applications 660 in accordance with exemplary embodiments. As illustrated, the application 660 comprises numerous functional components for implementing the features and operations of the exemplary embodiments. The application 660 of the computer 600 may represent various applications, computational units, logic, functional units, processes, operations, virtual entities, and/or modules in accordance with exemplary embodiments, but the application 660 is not meant to be a limitation.

The operating system 650 controls the execution of other computer programs, and provides scheduling, input-output control, file and data management, memory management, and communication control and related services. It is contemplated by the inventors that the application 660 for implementing exemplary embodiments may be applicable on all commercially available operating systems.

Application 660 may be a source program, executable program (object code), script, or any other entity comprising a set of instructions to be performed. When a source program, then the program is usually translated via a compiler (such as the compiler 640), assembler, interpreter, or the like, which may or may not be included within the memory 620, so as to operate properly in connection with the O/S 650. Furthermore, the application 660 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 670 may include input devices such as, for example but not limited to, a mouse, keyboard, scanner, microphone, camera, etc. Furthermore, the I/O devices 670 may also include output devices, for example but not limited to a printer, display, etc. Finally, the I/O devices 670 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 670 also include components for communicating over various networks, such as the Internet or intranet.

If the computer 600 is a PC, workstation, intelligent device or the like, the software in the memory 620 may further include a basic input output system (BIOS) (omitted for simplicity). The BIOS is a set of essential software routines that initialize and test hardware at startup, start the O/S 650, and support the transfer of data among the hardware devices. The BIOS is stored in some type of read-only-memory, such as ROM, PROM, EPROM, EEPROM or the like, so that the BIOS can be executed when the computer 600 is activated.

When the computer 600 is in operation, the processor 610 is configured to execute software stored within the memory 620, to communicate data to and from the memory 620, and to generally control operations of the computer 600 pursuant to the software. The application 660 and the O/S 650 are read, in whole or in part, by the processor 610, perhaps buffered within the processor 610, and then executed.

When the application 660 is implemented in software it should be noted that the application 660 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 660 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium may include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 660 is implemented in hardware, the application 660 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The technical effects and benefits of exemplary embodiments include a relatively small Nyquist rate radar that may operate continuously in some embodiments, and in burst mode in other embodiments.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A digital radar system, comprising:
a transmitter, the transmitter configured to transmit a signal;
a receiver, the receiver configured to receive a return signal; and
two analog to digital conversion (ADC) units, the ADC units configured to digitize the return signal at a rate higher than a Nyquist rate for the transmitted signal.

2. The digital radar system of claim 1, wherein the transmitted signal has a frequency of about 1 GHz, and the ADC units digitize the return signal at a rate of about 3 GHz.

3. The digital radar system of claim 1, further comprising a system memory configured to store the digitized signal.

4. The digital radar system of claim 3, further comprising a personal computer (PC) configured to perform signal processing and display of the digitized signal, the PC being connected to the system memory via a universal serial bus (USB) link.

5. The digital radar system of claim 4, further comprising an uplink buffer connected between the system memory and the PC.

6. The digital radar system of claim 5, wherein the digitized signal is transferred between the system memory and the PC via the uplink buffer, the transfer being performed asynchronously to transmission and receiving of the signal, and wherein transmission, receiving, digitizing, storing, and transferring of the signal are performed continuously until a halt command is received from the PC.

7. The digital radar system of claim 4, wherein transmission, receiving, digitizing and storing of the signal are performed continuously for a duration of a burst cycle, and data is transferred from the system memory to the PC at the end of the burst cycle.

8. The digital radar system of claim 7, wherein the burst cycle ends when the system memory is full.

9. The digital radar system of claim 1, wherein the receiver comprises two orthogonally oriented antennae, each of the two antennae being connected to a respective one of the two ADC units via a respective switch and a respective low-noise amplifier.

10. The digital radar system of claim 9, wherein the switches are configured to be open during signal transmission, and closed during receiving of the return signal.

11. The digital radar system of claim 1, wherein the digital radar system operates at a pulse repetition rate (PRR) of up to 10 MHz with 8 received radio frequency (RF) samples per pulse repetition interval (PRI).

12. The digital radar system of claim 1, wherein the digital radar system operates at a PRR of up to 19 KHz with 4K received RF samples per PRI.

13. A method of operating a digital radar, the method comprising:
transmitting a signal via a transmitter;
receiving a return signal via a receiver; and
digitizing the return signal by two analog to digital conversion (ADC) units at a rate higher than a Nyquist rate for the transmitted signal.

14. The method of claim 13, wherein the transmitted signal has a frequency of about 1 GHz, and the return signal is digitized at a rate of about 3 GHz.

15. The method of claim 13, further comprising storing the digitized signal in a system memory.

16. The method of claim 15, further comprising performing signal processing and display of the digitized signal on a personal computer (PC), the PC being connected to the system memory via a universal serial bus (USB) link.

17. The method of claim 16, further comprising transferring the digitized signal from the system memory to the PC via an uplink buffer asynchronously to transmission and receiving of the signal.

18. The method of claim 17, further comprising performing transmission, receiving, digitizing, and transferring of the signal continuously until a halt command is received from the PC.

19. The method of claim 16, further comprising performing transmission, receiving, and digitizing of the signal continuously for a duration of a burst cycle, and transferring the digitized signal directly from the system memory to the PC at the end of the burst cycle.

20. The digital radar system of claim 19, wherein the burst cycle ends when the system memory is full.
